(19) United States
(12) Patent Application Publication
(10) Pub. No.: US 2026/0161993 A1
(43) Pub. Date: Jun. 11, 2026

(54) Circuit Cutting Decision Based on Circuit Noise Prediction

(71) Applicant: Dell Products L.P., Round Rock, TX (US)

(72) Inventors: Rômulo Teixeira de Abreu PINHO, Niterói (BR); Miguel Paredes QUIÑONES, Campinas (BR); Micael Veríssimo de ARAÚJO, Rio de Janeiro (BR); João Victor da Fonseca PINTO, Rio de Janeiro (BR)

(21) Appl. No.: 18/970,716

(22) Filed: Dec. 5, 2024

(51) Int. Cl. G06N 10/70; G06N 10/60

(52) U.S. Cl. CPC G06N 10/70; G06N 10/60

(57) ABSTRACT

One example method includes receiving, as input, a quantum circuit, by an ML (machine learning) model trained to predict an error for the quantum circuit after error mitigation has been applied to that quantum circuit, solving, by the ML model, a circuit optimization problem for the quantum circuit, and the solving comprises balancing first and second objectives, that conflict with each other, to identify, for a circuit cutting process, subcircuits of the quantum circuit, running the subcircuits on computing hardware, based on the running of the subcircuits, identifying the subcircuits that need error mitigation, and mitigating the error in those subcircuits, and applying a circuit knitting process to corrected, and uncorrected, outputs of the subcircuits.

### TECHNOLOGICAL FIELD OF THE DISCLOSURE

Embodiments disclosed herein generally relate to quantum circuits. More particularly, at least some embodiments relate to systems, hardware, software, computer-readable media, and methods, for quantum circuit cutting operations based on circuit noise prediction.

### BACKGROUND

Quantum circuit cutting is an orchestration task that may be performed when a large quantum circuit cannot run, as a whole, on a unique piece of quantum hardware, because quantum computers have limitations on the depth and number of qubits. A circuit cutting operation cuts the large circuit into a group of smaller subcircuits that can be separately executed and thus enables the execution of large circuits across different quantum architectures or even enabling the combination of quantum hardware and simulation engines.

Quantum circuit cutting, or simply ‘circuit cutting,’ is typically a combinatorial problem that scales exponentially using classical computing. Often, cutting algorithms are implemented via optimization heuristics that aim to find good solutions for the cutting through the optimization to some metric of quality. Since the cutting problem is solved via classic computation, on classical infrastructure, enabling more efficient execution of cutting algorithms is important in the overall quantum workload orchestration process.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a method, according to one embodiment.

FIG. 2 discloses an example computing entity configured and operable to perform any of the disclosed methods, processes, and operations.

### DETAILED DESCRIPTION OF SOME EXAMPLE EMBODIMENTS

Embodiments disclosed herein generally relate to quantum circuits. More particularly, at least some embodiments relate to systems, hardware, software, computer-readable media, and methods, for quantum circuit cutting operations based on circuit noise prediction.

One or more example embodiments are directed to methods and/or architectures for implementing a quantum circuit cutting process. A method according to one embodiment may strike a balance or compromise between minimizing circuit cutting processes that may imply expensive subsequent circuit knitting processes, and realizing a noise reduction that can result from the use of smaller circuits that may be obtained with a circuit cutting process.

A method according to one embodiment may comprise operations including: creating a dataset of quantum circuits and, for each of the quantum circuits, obtaining a probability vector and a corrected probability vector; simulating the quantum circuits to obtain ground truth probability vectors for each; calculating respective error values based on the probability vectors and the corrected probability vectors; receiving, as input, a quantum circuit, by an ML (machine learning) model trained to predict an error for the input quantum circuit after error mitigation has been applied to that quantum circuit; solving, by the ML model, a circuit optimization problem for the input quantum circuit, and the solving comprises balancing first and second conflicting objectives to identify, for a circuit cutting process, subcircuits of the input quantum circuit; running the subcircuits on computing hardware; identifying the subcircuits that need error mitigation; and, applying a circuit knitting process to corrected, and uncorrected, outputs of the subcircuits.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is an embodiment may predicts an overall error for a quantum circuit after error correction has been performed. An embodiment may comprise an ML model that captures the behavior of quantum hardware, and identifies error mitigation. An embodiment may comprise a circuit cutting optimization model that creates a bi-objective optimization problem, and considers the minimization of the error of subcircuits. Various other aspects of one or more embodiments will be apparent from this disclosure.

### A. REFERENCES

Reference is made herein to various documents, listed below. These documents are incorporated herein in their respective entireties by this reference.
[1] Childs, Andrew M, Eddie Schoute, and Cem M Unsal. “Circuit Transformations for Quantum Architectures,” n.d., 29.
[2] U.S. patent application Ser. No. 18/345,173, titled “CIRCUIT CUTTING TAKING INTO ACCOUNT TRANSPILATION ERROR”, and filed Jun. 30, 2023.

### B. ASPECTS OF AN EXAMPLE CONTEXT FOR ONE OR MORE EMBODIMENTS

The following is a discussion of aspects of an example context for various embodiments. This discussion is not intended to limit the scope of the claims or this disclosure, or the applicability of the embodiments, in any way.

Circuit cutting (see [1]) is an orchestration task that is performed when a large quantum circuit cannot run on a unique piece of quantum hardware, because quantum computers have limitations on the depth and number of qubits. This cutting operation thus enables the execution of large circuits across different quantum architectures, and may enable the combination of quantum hardware and simulation engines to execute these large quantum circuits.

Cutting is typically a combinatorial problem that scales exponentially using classical computing infrastructure. Cutting algorithms may be implemented via optimization heuristics that aim to find good solutions for the cutting through the optimization to some metric of quality. Since the cutting problem may be solved via classic computation, on classical infrastructure, enabling more efficient execution of cutting algorithms can be important in the overall quantum workload orchestration process.

One factor that is not currently considered in conventional cutting processes is the effect of quantum transpilation. In brief, the transpilation process is the optimization of a circuit to run on a specific hardware by transforming a high-level representation of the circuit into one that contains only operations and that adheres to the topological constraints of the target quantum hardware. One of the objectives of the transpilation process is to increase the fidelity of the execution of the transpiled circuit on the target hardware.

In light of these, and other, considerations, and as discussed in further detail elsewhere herein, one embodiment comprises a method that uses circuit cutting optimization heuristics as an estimate of how much noise-induced error each candidate subcircuit incurs after error mitigation. By doing this, an embodiment may be able to find and submit circuits that satisfy the original resource-usage objectives of the circuit cutting algorithm while at the same time trying to minimize the overall noise-induced errors of the final result. Trying to estimate noise upfront potentially reduces the likelihood that potentially costly noise mitigation techniques be applied after the execution of each subcircuit. One embodiment may constitute an improvement over approaches (such as disclosed in [2]) by including an error minimization term directly into the cost function of the optimization problem, instead of representing the error as a lazy constraint.

### C. DETAILED DISCUSSION OF ASPECTS OF ONE OR MORE EMBODIMENTS

### C.1 Introduction

Circuit cutting typically considers only characteristics of the large circuit that must be cut, and the maximum number of qubits, that is, the circuit size, that can be run on the target hardware. Reference [2] discloses selection of a best cutting process by adding restrictions to a branch-and-bound optimization process. In such an approach, the transpilation process would have to be considered at the same time that the optimization process was being performed. This would, however, introduce a variety of significant problems.

One of such problems concerns computational cost. Although system noise can be obtained relatively easily if calibration data from the target hardware is available, addressing the actual noise-induced error of the subcircuit execution, such as by way of some error mitigation technique, can only be done after execution the circuit. Doing this for every possible cutting configuration of a circuit is impractical and prohibitive.

Another of such problems concerns the fact of conflicting objectives. In particular, post-processing of sub-circuit results, sometimes referred to as knitting or circuit knitting, is a very costly operation executed with classical algorithms, whose complexity increases exponentially with the number of circuits to knit after the circuits are executed. Consequently, cutting aims to minimize the number of cuts so that the sub-circuits achieve the maximal possible size supported by the target hardware. On the other hand, noise-induced errors generally decrease with smaller circuits, which would favor cutting solutions that create more sub-circuits. As a result, an all-in-one, multi-objective approach would be modelled with conflicting objectives, making it a difficult optimization problem.

As a final example of such problems, the approach disclosed in [2] applies restrictions to a branch-and-bound process whose aim is to prune candidate subtrees having poor roots. Such an approach, however, may still lead to a prohibitive number of evaluations of the associated restriction function, since the cutting problem is combinatorial, that is, the cutting problem has exponential complexity.

### C.2 Overview of Aspects of One Embodiment

One example embodiment comprises, along with a circuit cutting scheme, application of error mitigation to the subcircuits that are being generated from the cutting process. One embodiment may use a defined error mitigation technique tailored for the available hardware used on the circuit cutting scheme. The following discussion describes a circuit cutting scheme where, in addition to minimizing the circuit knitting classical overhead, the scheme includes the minimization of an approximation of the overall error, considering error mitigation.

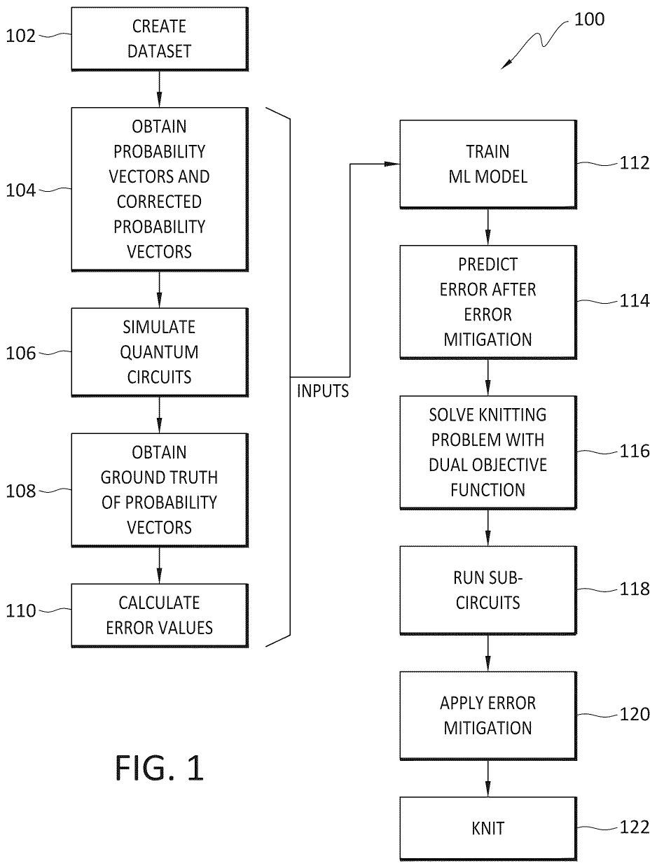

With reference now to FIG. 1, some aspects of an example method 100 according to one embodiment is disclosed. The example method 100 may begin with creation 102 of a dataset of quantum circuits. The quantum circuits may be run on quantum backend computing infrastructure, and a respective probability vector and corrected probability vector obtained 104 for each quantum circuit. As used herein, a probability vector is a vector that includes respective probabilities for different possible outcomes resulting from execution of a quantum circuit, since the output of the quantum circuit is not deterministic in nature. Thus, all the probabilities in a probability vector will add up to 1.

Next, the quantum circuits may be simulated 106, to obtain 108 respective ground truths for the probability vectors. Error values, which may be determined based on the ground truth probability vectors and the corrected probability vectors, may then be calculated 110 for each of quantum circuits. In an embodiment, the information obtained at 104, 106, 108, and 110, may be used as inputs for training 112 an ML model. The trained ML model operates to predict 114 an error of a quantum circuit after error mitigation has been performed with respect to that quantum circuit.

A dual objective function may then be used to solve 116 a circuit knitting problem for the sub-circuits of the quantum circuit. The sub-circuits may then be run 118, and a determination made as to which sub-circuits will have error mitigation applied, and that error mitigation then applied 120 to those sub-circuits. Finally, the sub-circuits, both those that have had error mitigation application, and those that have not, may be knit 122 together.

### C.3 Discussion

Following, a detailed discussion is provided concerning one example embodiment. This embodiment comprises a method that minimizes a classical computing overhead for a circuit knitting scheme, while also minimizing an approximation of the overall error, taking into account the application of error mitigation. As used herein, such ‘error’ comprises noise-induced error that may result from execution of a quantum circuit, or a sub-circuit of a quantum circuit. Thus, a circuit cutting function according to an embodiment includes a term that estimates the amount of noise for each candidate subcircuit given a target backend. The noise estimator, which may take the form of an ML model, is trained with the differences between ideal state vectors and their noisy versions obtained via simulations of the quantum sub-circuits.

In more detail, and with continued reference to the example of FIG. 1, an embodiment may comprise a method that includes the following operations:
1. create a dataset of quantum circuits C, that are required to be run in quantum backends B, and obtain probability vectors V and corrected probability vectors V using a defined error correcting model for backend B-then use efficient simulators, such as Tensor Network (TN) simulators, to simulate the circuits C to obtain ground truth probability vectors V*, and calculate error values e defined as e=1−f where f(v*, \hat{v}) is the fidelity after apply the error mitigation method.
2. use the data obtained at 1. to train an ML model M(c, xᵢ, yᵢ, θ), where xᵢ, and yᵢ are variables that define subcircuit i from large circuit c, and θ are the trainable variables of model M—the ML model M operates to predict the error ê associated after error mitigation has been applied to a quantum sub-circuit—one of the conditions of one embodiment of model M is that it must be differentiable on all the variables, the trainable and the input variables.
3. add an objective function to a circuit cutting optimization problem, where the objective function comprises a dual objective function that minimizes the expected error after error mitigation by including the following function:

$${L}_{2} = {\sum }_{i} max {( ϵ , M ( c , {x}_{i} , {y}_{i} ) )}^{2}$$

where L₂ is a second term of a bi-objective circuit cutting optimization problem—this is a penalization scheme of an inequality constraint M(c, xᵢ, yᵢ)<∈ that assures that predicted mitigated error is less than a threshold ∈—since the problem is a bi-objective problem that combines the objective function related to the minimization of circuit knitting efforts L₁ with the function L₂, the following final objective function may be defined:

$$L = {L}_{1} + α {L}_{2}$$

where α is a weight parameter that escalates both objective functions L₁ and L₂—this weight parameter may also be set at a large number to penalize a large amount of error—it is noted that the objectives conflict with each other since L₁ seeks to minimize the number of circuits to be knitted, while L₂ maximizes the number of subcircuits in order to realize less error by circuit.
4. once the modified circuit cutting problem is solved, the sub-circuits are each run in defined quantum hardware.
5. before the circuit knitting step—an embodiment may determine which subcircuits will need error mitigation by checking if the predicted errors M (c, xᵢ, yᵢ) are greater than ∈.
6. finally, a circuit knitting process is applied to both the corrected and uncorrected subcircuit outputs, and the quantum circuit produced by the knitting process may be run on suitable quantum hardware.

By way of contrast with an error prediction model and circuit cutting approach disclosed in [2], an embodiment may comprise a method for predicting error mitigated outputs. Another contrast is that a method according to one embodiment does not use a minimum error constraint as a lazy constraint to be verified during a branch-and-bound scheme. Rather, an embodiment uses a penalization method that is an improvement over use of a lazy constraint at in the sense of having a gradient direction for the objective function that is influenced by the error prediction, while using lazy constraints as in [2] requires substantial computing resources, and time, to search an exponential number of nodes in a branch-and-bound scheme.

### C.4 Further Discussion

As disclosed herein, one or more embodiments may comprise various useful features and aspects, although no embodiment is required to possess any of such features or aspects. The following examples are illustrative, but not exhaustive. For example, an embodiment May comprise an ML model that predicts the overall error after error correction. The model may model capture the behavior of the quantum hardware, and in conjunction with that, may also comprise an error mitigation algorithm. A method may comprise a circuit cutting optimization model that creates a bi-objective, or dual objective, optimization problem, one aim of which is the minimization of the error of subcircuits.

In contrast, the approach disclosed in [2], and as alluded to earlier herein, depends on the execution of a restriction function for every node of the discrete candidate solution tree, resulting in a requirement for a large amount of computing resources. On the other hand, an embodiment may comprise various functionalities. For example, an embodiment may consider noise-induced, post-execution error estimates as a restriction for the cutting heuristics, which goes further than simply considering transpilation-associated errors. As another example, an embodiment may comprise this restriction as derivable term directly into an optimization cost function, which makes the optimization follow a more natural continuous trajectory towards the optimal solution.

### D. EXAMPLE METHODS

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### E. FURTHER EXAMPLE EMBODIMENTS

Following are some further example embodiments. These are presented only by way of example and are not intended to limit the scope of this disclosure or the claims in any way.

Embodiment 1. A method, comprising: receiving, as input, a quantum circuit, by an ML (machine learning) model trained to predict an error for the quantum circuit after error mitigation has been applied to that quantum circuit; solving, with aid from the ML model, a circuit optimization problem for the quantum circuit, and the solving comprises balancing first and second objectives, that conflict with each other, to identify, for a circuit cutting process, subcircuits of the quantum circuit; running the subcircuits on computing hardware; based on the running of the subcircuits, identifying the subcircuits that need error mitigation, and mitigating the error in those subcircuits; and applying a circuit knitting process to corrected, and uncorrected, outputs of the subcircuits.

Embodiment 2. The method as recited in any preceding embodiment, wherein the ML model was trained with a dataset comprising a set of quantum circuits, respective probability vectors for each of the quantum circuits, respective corrected probability vectors for each of the quantum circuits, respective ground truths for the probability vectors, and respective error values for each of the quantum circuits.

Embodiment 3. The method as recited in embodiment 2, wherein the error values were obtained using the probability vectors, and the corrected probability vectors.

Embodiment 4. The method as recited in embodiment 2, wherein each of the error values is based on a respective fidelity of one of the quantum circuits, after error mitigation has been applied to the quantum circuit.

Embodiment 5. The method as recited in any preceding embodiment, wherein the first objective is minimizing a number of cuts made by the circuit cutting process, and the second objective is maximizing a number of the subcircuits in order to reduce an overall error of the quantum circuit.

Embodiment 6. The method as recited in any preceding embodiment, wherein the ML model predicts an expected overall error for the quantum circuit after error mitigation has been performed.

Embodiment 7. The method as recited in any preceding embodiment, wherein the error comprises noise-induced error.

Embodiment 8. The method as recited in any preceding embodiment, wherein the second objective is a penalization scheme of an inequality constraint that assures that a mitigated error, predicted by the ML model, is less than a threshold error.

Embodiment 9. The method as recited in any preceding embodiment, wherein the subcircuits are run in defined hardware.

Embodiment 10. The method as recited in any preceding embodiment, wherein the optimization problem is solved on classical computing infrastructure.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

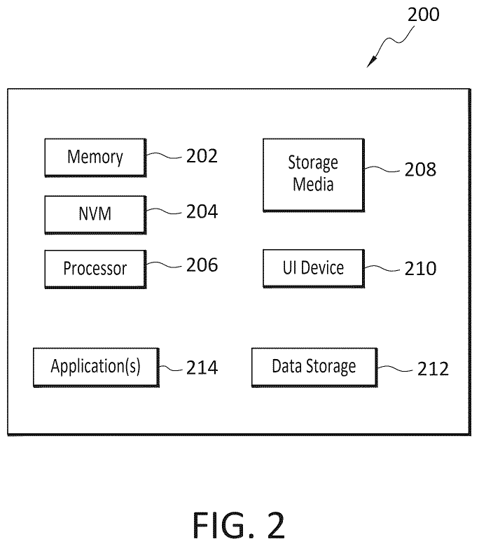

With reference briefly now to FIG. 2, any one or more of the entities disclosed, or implied, by FIG. 1, and/or elsewhere herein, may take the form of, or include, or be implemented on, or hosted by, a physical computing device, one example of which is denoted at 200. As well, where any of the aforementioned elements comprise or consist of a virtual machine (VM), that VM may constitute a virtualization of any combination of the physical components disclosed in FIG. 2.

In the example of FIG. 2, the physical computing device 200 includes a memory 202 which may include one, some, or all, of random access memory (RAM), non-volatile memory (NVM) 204 such as NVRAM for example, read-only memory (ROM), and persistent memory, one or more hardware processors 206, non-transitory storage media 208, UI device 210, and data storage 212. One or more of the memory components 202 of the physical computing device 200 may take the form of solid state device (SSD) storage. As well, one or more applications 214 may be provided that comprise instructions executable by one or more hardware processors 206 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
receiving, as input, a quantum circuit, by an ML (machine learning) model trained to predict an error for the quantum circuit after error mitigation has been applied to that quantum circuit;
solving, with aid from the ML model, a circuit optimization problem for the quantum circuit, and the solving comprises balancing first and second objectives, that conflict with each other, to identify, for a circuit cutting process, subcircuits of the quantum circuit;
running the subcircuits on computing hardware;
based on the running of the subcircuits, identifying the subcircuits that need error mitigation, and mitigating the error in those subcircuits; and
applying a circuit knitting process to corrected, and uncorrected, outputs of the subcircuits.

2. The method as recited in claim 1, wherein the ML model was trained with a dataset comprising a set of quantum circuits, respective probability vectors for each of the quantum circuits, respective corrected probability vectors for each of the quantum circuits, respective ground truths for the probability vectors, and respective error values for each of the quantum circuits.

3. The method as recited in claim 2, wherein the error values were obtained using the probability vectors, and the corrected probability vectors.

4. The method as recited in claim 2, wherein each of the error values is based on a respective fidelity of one of the quantum circuits, after error mitigation has been applied to the quantum circuit.

5. The method as recited in claim 1, wherein the first objective is minimizing a number of cuts made by the circuit cutting process, and the second objective is maximizing a number of the subcircuits in order to reduce an overall error of the quantum circuit.

6. The method as recited in claim 1, wherein the ML model predicts an expected overall error for the quantum circuit after error mitigation has been performed.

7. The method as recited in claim 1, wherein the error comprises noise-induced error.

8. The method as recited in claim 1, wherein the second objective is a penalization scheme of an inequality constraint that assures that a mitigated error, predicted by the ML model, is less than a threshold error.

9. The method as recited in claim 1, wherein the subcircuits are run in defined hardware.

10. The method as recited in claim 1, wherein the optimization problem is solved on classical computing infrastructure.

11. A non-transitory storage medium having stored therein instructions that are executable by one or more hardware processors to perform operations comprising:
receiving, as input, a quantum circuit, by an ML (machine learning) model trained to predict an error for the quantum circuit after error mitigation has been applied to that quantum circuit;
solving, with aid from the ML model, a circuit optimization problem for the quantum circuit, and the solving comprises balancing first and second objectives, that conflict with each other, to identify, for a circuit cutting process, subcircuits of the quantum circuit;
running the subcircuits on computing hardware;
based on the running of the subcircuits, identifying the subcircuits that need error mitigation, and mitigating the error in those subcircuits; and
applying a circuit knitting process to corrected, and uncorrected, outputs of the subcircuits.

12. The non-transitory storage medium as recited in claim 11, wherein the ML model was trained with a dataset comprising a set of quantum circuits, respective probability vectors for each of the quantum circuits, respective corrected probability vectors for each of the quantum circuits, respective ground truths for the probability vectors, and respective error values for each of the quantum circuits.

13. The non-transitory storage medium as recited in claim 12, wherein the error values were obtained using the probability vectors, and the corrected probability vectors.

14. The non-transitory storage medium as recited in claim 12, wherein each of the error values is based on a respective fidelity of one of the quantum circuits, after error mitigation has been applied to the quantum circuit.

15. The non-transitory storage medium as recited in claim 11, wherein the first objective is minimizing a number of cuts made by the circuit cutting process, and the second objective is maximizing a number of the subcircuits in order to reduce an overall error of the quantum circuit.

16. The non-transitory storage medium as recited in claim 11, wherein the ML model predicts an expected overall error for the quantum circuit after error mitigation has been performed.

17. The non-transitory storage medium as recited in claim 11, wherein the error comprises noise-induced error.

18. The non-transitory storage medium as recited in claim 11, wherein the second objective is a penalization scheme of an inequality constraint that assures that a mitigated error, predicted by the ML model, is less than a threshold error.

19. The non-transitory storage medium as recited in claim 11, wherein the subcircuits are run in defined hardware.

20. The non-transitory storage medium as recited in claim 11, wherein the optimization problem is solved on classical computing infrastructure.
